(19) United States
(12) Patent Application Publication
(10) Pub. No.: US 2017/0045833 A1
(43) Pub. Date: Feb. 16, 2017

(54) METHOD FOR PRODUCING METAL CYLINDER, METHOD FOR PRODUCING SUBSTRATE FOR ELECTROPHOTOGRAPHIC PHOTOCONDUCTOR, METHOD FOR MANUFACTURING ELECTROPHOTOGRAPHIC PHOTOCONDUCTOR, AND METAL SLUG FOR IMPACT PRESSING

(71) Applicant: FUJI XEROX CO., LTD., Tokyo (JP)

(72) Inventors: Akira SATO, Kanagawa (JP); Kazuyuki TADA, Kanagawa (JP); Masahiro ANDOH, Kanagawa (JP); Hiroshi TAMEMASA, Kanagawa (JP)

(73) Assignee: FUJI XEROX CO., LTD., Tokyo (JP)

(21) Appl. No.: 15/010,521

(22) Filed: Jan. 29, 2016

(30) Foreign Application Priority Data
Aug. 12, 2015 (JP) 2015-159702

(51) Int. Cl. G03G 5/00; B24B 31/02; B21J 5/00

(52) U.S. Cl. CPC G03G 5/005; B21J 5/002; B24B 31/02; B05D 1/18

(57) ABSTRACT

A method for producing a metal cylinder includes preparing a metal slug having a polished surface, and molding the metal slug into a cylinder by impact-pressing with the polished surface as a bottom.

### CROSS-REFERENCE TO RELATED APPLICATIONS

This application is based on and claims priority under 35 USC 119 from Japanese Patent Application No. 2015-159702 filed Aug. 12, 2015.

### BACKGROUND

(i) Technical Field

The present invention relates to a method for producing a metal cylinder, a method for producing a substrate for an electrophotographic photoconductor, a method for manufacturing an electrophotographic photoconductor, and a metal slug for impact pressing.

(ii) Related Art

An apparatus which sequentially performs charging, exposure, development, transfer, cleaning, etc. by using an electrophotographic photoconductor (may be referred to as a “photoconductor” hereinafter) has been widely known as an electrophotographic image forming apparatus.

Known electrophotographic photoconductors include a function-separation-type photoconductor in which a charge generation layer that generates charge by exposure and a charge transport layer that transports charge are laminated on a support having conductivity such as an aluminum support or the like, and a single-layer-type photoconductor in which the same layer performs both the function of generating charge and the function of transporting charge.

For example, a method of adjusting the thickness, surface roughness, and the like of an aluminum element tube by cutting the peripheral surface thereof is known as a method for producing a cylindrical substrate serving as a conductive support of an electrophotographic photoconductor.

On the other hand, impact pressing for forming a cylinder by applying impact with a punch to a metal slug placed in a die (female die) is known as a method for mass-producing a thin metal container or the like at low cost.

### SUMMARY

According to an aspect of the invention, there is provided a method for producing a metal cylinder including preparing a metal slug having a polished surface, and forming a cylinder by impact pressing of the metal slug having the polished surface as a bottom.

### BRIEF DESCRIPTION OF THE DRAWINGS

Exemplary embodiments of the present invention will be described in detail based on the following figures, wherein:

FIGS. 1A to 1C are schematic views showing an example of impact pressing in a method for producing a metal cylinder according to an exemplary embodiment of the invention;

FIGS. 2A and 2B are schematic views showing an example of drawing and fine ironing in a method for producing a metal cylinder according to an exemplary embodiment of the invention;

FIG. 3 is a schematic partial sectional view showing an example of a configuration of an electrophotographic photoconductor manufactured by a method for manufacturing an electrophotographic photoconductor according to an exemplary embodiment of the invention;

FIG. 4 is a schematic partial sectional view showing another example of a configuration of an electrophotographic photoconductor manufactured by a method for manufacturing an electrophotographic photoconductor according to an exemplary embodiment of the invention;

FIG. 5 is a schematic partial sectional view showing a further example of a configuration of an electrophotographic photoconductor manufactured by a method for manufacturing an electrophotographic photoconductor according to an exemplary embodiment of the invention;

FIG. 6 is a schematic configuration diagram showing an example of an image forming apparatus according to an exemplary embodiment of the invention; and

FIG. 7 is a schematic configuration diagram showing another example of an image forming apparatus according to an exemplary embodiment of the invention.

### DETAILED DESCRIPTION

Exemplary embodiments of the present invention are described below with reference to the drawings. In the drawings, elements having the same function are denoted by the same reference numeral, and duplicate description is eliminated.

### [Method for Producing Metal Cylinder]

A method for producing a metal cylinder according to an exemplary embodiment of the invention includes preparing a metal slug having a polished surface, and forming a cylinder by impact pressing of the metal slug having the polished surface as a bottom.

In general impact pressing, for example, a metal slug of aluminum or the like (may be referred to as a “slug” hereinafter) is disposed in a circular female die, and a cylinder may be instantaneously formed along a cylindrical male die by striking with the die under high pressure.

For example, when a cylindrical substrate for an electrophotographic photoconductor is produced by impact pressing, the electrophotographic photoconductor is produced by molding a cylindrical aluminum tube by impact pressing, then adjusting the inner and outer diameters, cylindricity, and circularity by ironing, and further forming a photosensitive layer and the like on the outer peripheral surface of the cylinder.

However, when a cylinder is molded by impact pressing, many fine recesses (recessed portions) may be produced at specific positions, and there is an individual difference in the number of recessed portions. When a toner image is formed by an image forming apparatus provided with an electrophotographic photoconductor manufactured by forming a photosensitive layer and the like on the outer peripheral surface of such a cylinder having many recessed portions, an output image is influenced by the recessed portions present on the outer peripheral surface of the cylinder depending on the size of the recessed portions, and thus dot defects may occur in the image.

When a cylinder is produced by impact pressing, a conceivable cause for the occurrence of a recessed portion is a fine crack present in the surface of the metal slug before impact pressing. For example, when the size of a crack present in the surface of the slug is about 20 μm, impact pressing is considered to enlarge the crack to a recessed portion of about 300 μm.

On the other hand, the method for producing a metal cylinder according to the exemplary embodiment of the invention may produce a metal cylinder with suppressed occurrence of recessed portions in the outer peripheral surface. The reason for this is considered as follow.

In impact pressing of the metal slug having the polished surface as the bottom, the bottom of the metal slug before impact pressing is partially extended to form the peripheral surface of the cylinder. Therefore, the surface properties of the polished surface of the metal slug are reflected in the outer peripheral surface of the cylinder, thereby suppressing the occurrence of recessed portions.

The case of production of a cylindrical substrate for an electrophotographic photoconductor is specifically described as an example of the method for producing a metal cylinder according to the exemplary embodiment of the invention.

For example, when a cylindrical substrate for an electrophotographic photoconductor is produced by the method for producing a metal cylinder according to the exemplary embodiment of the invention, a metal slug having a polished surface is prepared, the metal slug is molded into a cylinder by impact pressing of the metal slug with the polished surface as a bottom, and the peripheral surface of the cylinder is ironed. Each of the processes is described in detail below.

### <Preparation>

In the preparation, the metal slug having the polished surface is prepared.

The material, shape, size, etc. of the slug may be selected according to application of the metal cylinder produced.

When the cylindrical substrate constituting an electrophotographic photoconductor is produced, an aluminum or aluminum alloy-made disk or cylindrical slug is used.

In addition, an elliptic cylindrical or prismatic slug, or the like may be used according to application of the metal cylinder produced.

Examples of an aluminum alloy contained in the slug include aluminum alloys containing aluminum and Si, Fe, Cu, Mn, Mg, Cr, Zn, Ti, or the like.

The aluminum alloy contained in the slug used for producing the cylindrical substrate of the electrophotographic photoconductor is a so-called 1000-series alloy.

From the viewpoint of workability, the aluminum content (aluminum purity:weight ratio) in the slug is preferably 90.0% or more, more preferably 93.0% or more, and further preferably 95.0% or more.

A method for forming the (unpolished) slug before polishing is not limited and, for example, when the cylindrical or disk-shaped slug is used, examples of the method include a method of cutting a rod-shaped metal material having a circular section perpendicular to a longitudinal direction into a length corresponding to the height (thickness) of the slug, a method of punching a circular shape in a metal plate having a thickness corresponding to the height (thickness) of the slug, and the like.

A method for polishing the unpolished slug is not limited, and the polishing method may be selected according to the constituent material, shape, etc. of the slug.

The slug used in the exemplary embodiment may have the polished surface as the bottom (the surface opposite to the surface struck with a male die) in impact pressing. From the viewpoint of efficient polishing, for example, the entire surface of the slug is polished by a method of barrel polishing such as vibrating barrel polishing, centrifugal barrel polishing, or the like. The barrel polishing may be a dry type or a wet type, but wet centrifugal barrel polishing is performed from the viewpoint of efficient polishing within a short time.

The amount of polishing (polishing amount) of the unpolished slug is preferably 5 μm or more, more preferably 10 μm or more, and particularly preferably 20 μm or more from the viewpoint of decreasing the surface roughness of the polished surface and improving the non-defective rate of a metal cylinder. On the other hand, from the viewpoint of suppressing a decrease in yield of polishing due to excessive polishing, the polishing amount is preferably 30 μm or less.

From the viewpoint of suppressing the occurrence of recessed portions in the outer peripheral surface of the metal cylinder produced, the surface roughness (center-line average roughness) Ra of the polished surface of the slug is preferably less than 5 μm, more preferably 3 μm or less, and further preferably 1 μm or less. On the other hand, when the polished surface of the slug has excessively small surface roughness, lubricating oil less adheres to the surface of the slug, and thus the slug easily adheres to the female die. Thus, the surface roughness Ra of the polished surface of the slug is preferably 0.5 μm or more.

A value of surface roughness Ra in the exemplary embodiment is center-line average roughness defined by JIS B0601 (1982) and is a value measured by a surface roughness measuring instrument (Surfcom, manufactured by Tokyo Seimitsu Co., Ltd.).

### <Impact Pressing>

In the impact pressing, a cylinder is formed by impact pressing of the metal slug with the polished surface as the bottom.

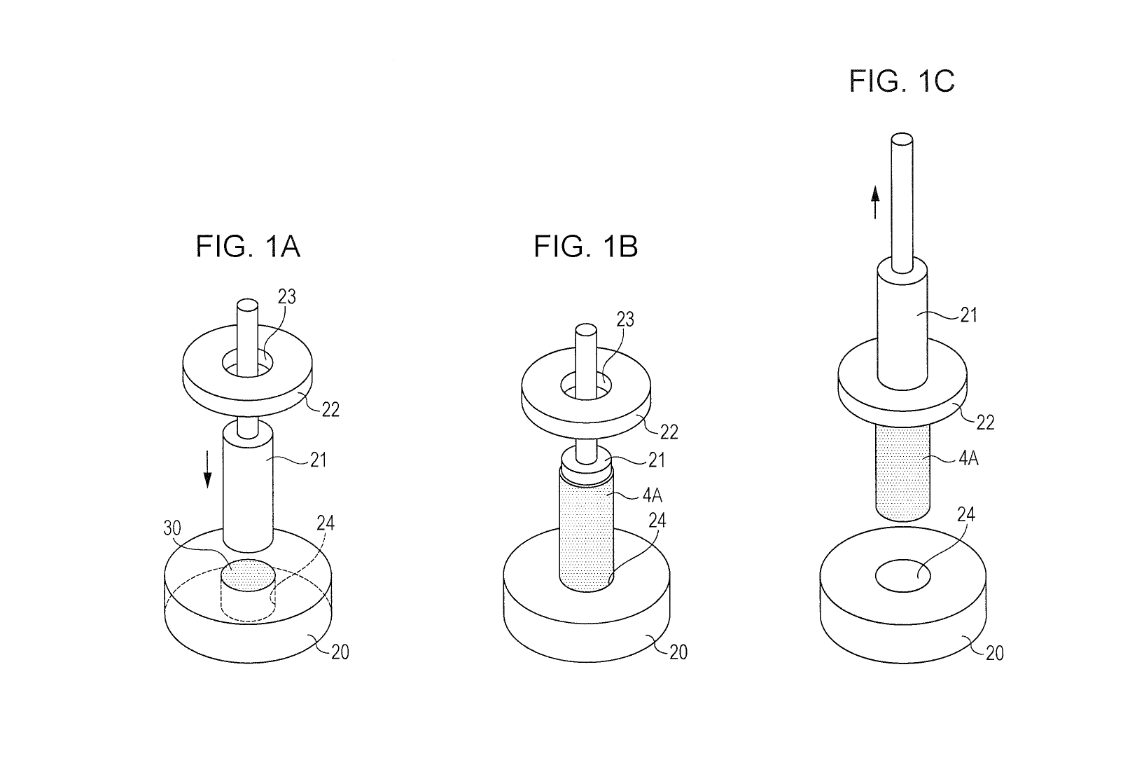

FIGS. 1A to 1C show an example of molding of the cylinder by impact pressing of the slug after polishing.

A lubricant is applied to a slug 30 after polishing, and the slug 30 is placed in a circular hole 24 provided in a die (female die) 20 as shown in FIG. 1A. In this case, the slug 30 is placed in the die 20 so that the polished surface is located at the bottom. When the cylindrical slug is polished by vibrating barrel polishing or centrifugal barrel polishing in the preparation, the entire surface of the slug has been polished, and thus the cylindrical slug may be placed in the die 20 so that any one of the end surfaces of the cylindrical slug is located at the bottom.

Next, as shown in FIG. 1B, the slug 30 placed in the die 20 is pressed by a punch (male die) 21. Consequently, the slug 30 is extended cylindrically from the circular hole of the die 20 so as to cover the periphery of the punch 21. In this case, the bottom of the slug 30 before impact pressing is extended to form the outer peripheral surface of a cylinder 4A, and thus the surface roughness of the bottom of the slug 30 is reflected in the surface roughness of the outer peripheral surface of a cylinder 4A.

After molding, as shown in FIG. 1C, the punch 21 is removed by being pulled up and passed through a central holed of the stripper 22, thereby producing the cylindrical compact (cylinder) 4A.

The impact pressing suppresses the occurrence of recessed portions in the outer peripheral surface. In addition, hardness is increased by work hardening, and thus the cylindrical compact (cylinder) 4A having a small thickness and high hardness may be produced.

The thickness of the cylinder 4A is not particularly limited, but for example, when the cylinder 4A is produced as a cylindrical substrate for an electrophotographic photoconductor, the thickness of the cylinder 4A molded by impact pressing is preferably 0.4 mm or more and 0.8 mm or less and more preferably 0.4 mm or more and 0.6 mm or less from the viewpoint of processing to a thickness of, for example, 0.2 mm or more and 0.9 mm or less by subsequent ironing while maintaining hardness.

### <Ironing>

In the ironing, the inner and outer diameters, cylindricity, circularity, etc. are adjusted by ironing the cylinder molded by impact pressing.

When the cylindrical substrate for an electrophotographic photoconductor is produced by using the method for producing a metal cylinder according to the exemplary embodiment, the ironing is performed. However, the ironing may be performed according to demand in view of the purpose of the metal cylinder produced.

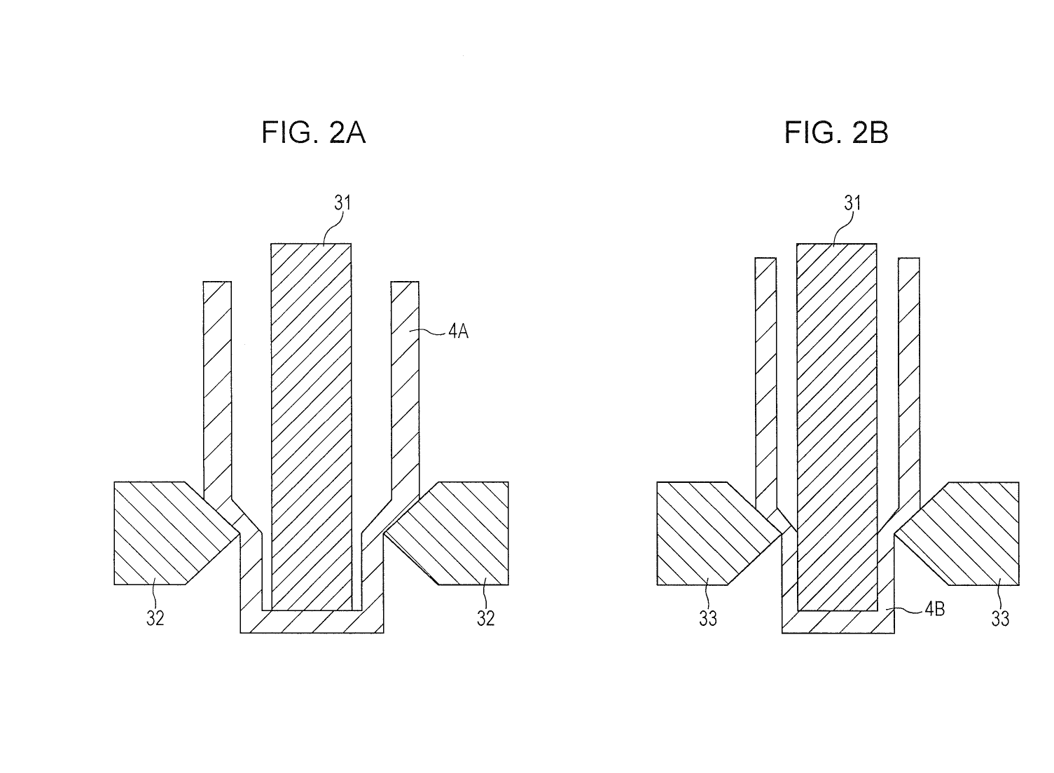

Specifically, as shown in FIG. 2A, if required, the cylinder 4A molded by impact pressing is pushed from the inner side into a die 32 using a cylindrical punch 31 to decrease the diameter by drawing. Then, as shown in FIG. 2B, the cylinder 4A is pushed into a die 33 having a smaller diameter to perform ironing. The ironing may be performed without drawing, or the ironing may be divided in plural steps. The thickness of a cylinder 4B is adjusted by the number of times of ironing.

Also, stress may be released by annealing before ironing.

The thickness of the cylinder 4B after ironing is preferably 0.2 mm or more and 0.9 mm or less and more preferably 0.4 mm or more and 0.6 mm or less from the viewpoint of maintaining the hardness as a substrate for an electrophotographic photoconductor.

Therefore, when ironing is performed after the cylinder 4A is molded by impact pressing according to the exemplary embodiment, the cylindrical substrate having little recessed portions in the outer peripheral surface, a thin thickness, light weight, and high hardness may be produced.

The method for producing a metal cylinder according to the exemplary embodiment suppresses the occurrence of recessed portions in the outer peripheral surface and thus may produce a cylindrical substrate of quality equivalent to or higher than a substrate produced by a cutting method. Also, in mass production of metal cylinders, an automatic surface test may be eliminated.

When the photoconductor is used for a laser printer, the oscillation wavelength of a laser is preferably 350 nm or more and 850 nm or less, and the shorter the wavelength is, the more excellent resolution is. The surface of the cylindrical substrate is roughened to a surface roughness Ra of 0.04 μm or more and 0.5 μm or less in order to prevent the occurrence of interference fringes during laser beam irradiation. With a Ra of 0.04 μm or more, an interference preventing effect is obtained, while with a Ra of 0.5 μm or less, the tendency toward rough image quality is effectively suppressed.

In addition, when incoherent light is used as a light source, roughening for preventing interference fringes is not particularly required, and the occurrence of defects due to irregularity in the surface of the cylindrical substrate may be prevented, thereby causing suitability for longer lifetime.

Examples of a roughening method include wet horning treatment of spraying a suspension of an abrasive in water to the cylindrical substrate, center-less grinding treatment of continuously grinding the cylindrical substrate in pressure-contact with a rotating grindstone, anodization treatment, a method of forming a layer containing organic or inorganic semiconductor particles, and the like.

The anodization treatment includes forming an oxide film on an aluminum surface by anodization using aluminum as an anode in an electrolyte solution. Examples of the electrolyte solution include a sulfuric acid solution, an oxalic acid solution, and the like. However, a porous anodized film as it is after the treatment is chemically active and is easily contaminated and has a large variation in resistance with environment. Therefore, sealing treatment is performed by treating the anodized film with steam under pressure or boiling water (to which a metal salt of nickel or the like may be added) to seal micro-pores by hydration reaction volume expansion and to convert the oxide to more stable hydrous oxide.

The thickness of the anodized film is preferably 0.3 μm or more and 15 μm or less. With a thickness of less than 0.3 μm, there is the tendency toward an insufficient effect due to a lack of barrier property against injection. Also, with a thickness exceeding 15 μm, there is the tendency to induce an increase in remaining potential by repeated use.

The outer peripheral surface of the cylindrical substrate may be treated with an acid treatment solution or boehmite.

The treatment with an acid treatment solution is performed by using an acid treatment solution containing phosphoric acid, chromic acid, and hydrofluoric acid as described below. With respect to the ratios of phosphoric acid, chromic acid, and hydrofluoric acid mixed in the acid treatment solution, the ratio of phosphoric acid is within a range of 10% by weight or more and 11% by weight or less, the ratio of chromic acid is within a range of 3% by weight or more and 5% by weight or less, the ratio of hydrofluoric acid is within a range of 0.5% by weight or more and 2% by weight or less, and the total concentration of the acids is preferably 13.5% by weight or more and 18% by weight or less. The treatment temperature is 42° C. or more and 48° C. or less, but a thick film may be more rapidly formed by maintaining the treatment temperature high. The thickness of the film is preferably 0.3 μm or more and 15 μm or less.

The boehmite treatment is performed by immersing the cylindrical substrate in pure water at 90° C. or more 100° C. or less for 5 minutes or more and 60 minutes or less or by bringing the cylindrical substrate in contact with heated steam at 90° C. or more 120° C. or less for 5 minutes or more and 60 minutes or less. The thickness of the film is preferably 0.1 μm or more and 5 μm or less. The film may further anodized by using an electrolyte solution with low film solubility, such as a solution of adipic acid, boric acid, borate, phosphate, phthalate, maleate, benzoate, tartrate, citrate, or the like.

### [Method for Manufacturing Electrophotographic Photoconductor]

A method for manufacturing an electrophotographic photoconductor according to an exemplary embodiment includes preparing, as a substrate for an electrophotographic photoconductor, a metal cylinder produced by the method for producing a metal cylinder according to the exemplary embodiment, and forming a photosensitive layer on the outer peripheral surface of the substrate for an electrophotographic photoconductor.

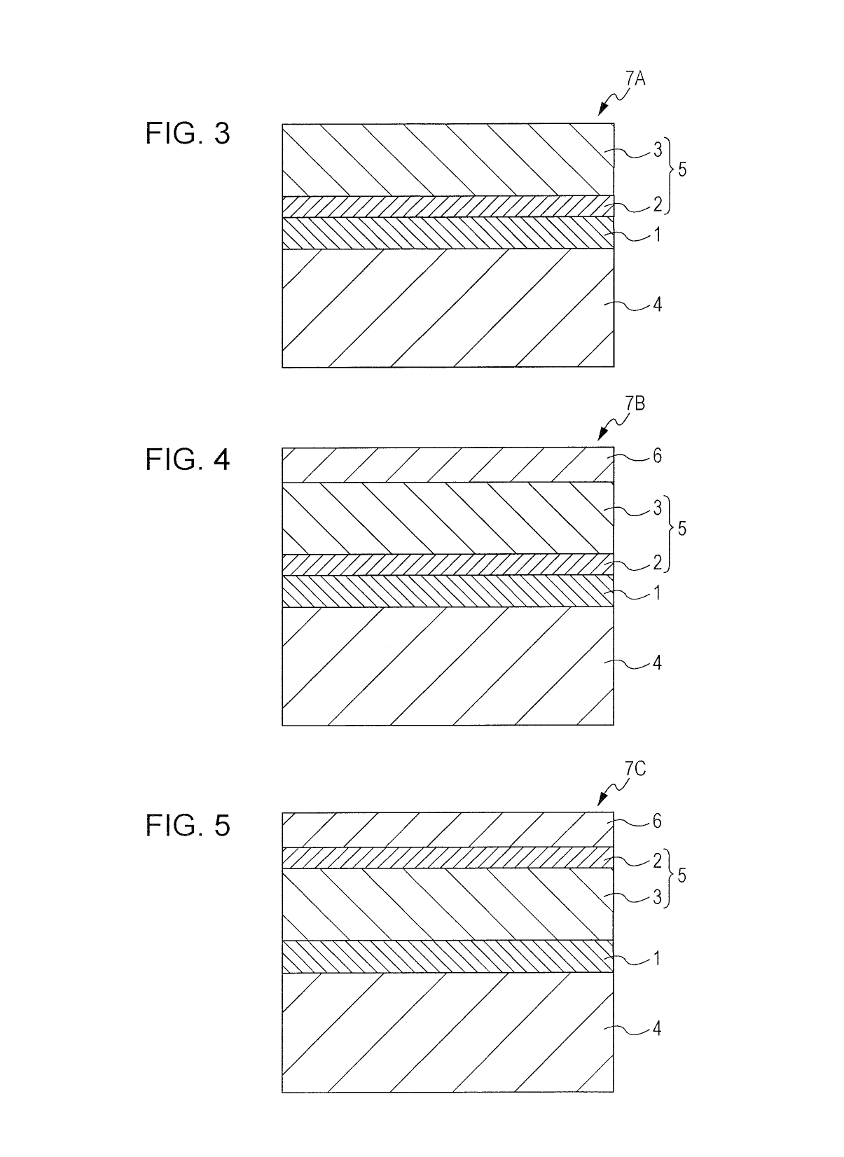

FIG. 3 is a schematic partial sectional view showing an example of a layer configuration of an electrophotographic photoconductor produced by the method for manufacturing an electrophotographic photoconductor according to the exemplary embodiment. An electrophotographic photoconductor 7A shown in FIG. 3 has a structure in which an undercoat layer 1, a charge generation layer 2, and a charge transport layer 3 are laminated in that order on a cylindrical substrate 4, and the charge generation layer 2 and the charge transport layer 3 constitute a photosensitive layer 5.

FIGS. 4 and 5 are each a schematic partial sectional view showing another example of a layer configuration of an electrophotographic photoconductor manufactured by a method for manufacturing an electrophotographic photoconductor according to the exemplary embodiment.

Like in the electrophotographic photoconductor 7A shown in FIG. 3, in the electrophotographic photoconductors 7B and 7C shown in FIGS. 4 and 5, respectively, the function of a photosensitive layer 5 is separated into a charge generation layer 2 and a charge transport layer 5, and a protecting layer 6 is formed as an outermost layer. The electrophotographic photoconductor 7B shown in FIG. 4 has a structure in which the undercoat layer 1, the charge generation layer 2, the charge transport layer 3, and the protecting layer 6 are laminated in that order on the cylindrical substrate 4. The electrophotographic photoconductor 7C shown in FIG. 5 has a structure in which the undercoat layer 1, the charge transport layer 3, the charge generation layer 2, and the protecting layer 6 are laminated in that order on the cylindrical substrate 4.

Further, each of the electrophotographic photoconductors 7A to 7C may not be necessarily provided with the undercoat layer 1. Also, each of the electrophotographic photoconductors 7A to 7C may include a single-layer photosensitive layer in which the functions of the charge generation layer 2 and the charge transport layer 3 are integrated.

### [Image Forming Apparatus (and Process Cartridge)]

An image forming apparatus according to an exemplary embodiment includes an electrophotographic photoconductor manufactured by the method for manufacturing an electrophotographic photoconductor according to the exemplary embodiment, a charging unit that charges the surface of the electrophotographic photoconductor, an electrostatic latent image forming unit that forms an electrostatic latent image on the surface of the charged electrophotographic photoconductor, a development unit that develops, with a developer containing a toner, the electrostatic latent image formed on the surface of the electrophotographic photoconductor to form a toner image, and a transfer unit that transfers the toner image to a surface of a recording medium.

The image forming apparatus according to the exemplary embodiment includes the electrophotographic photoconductor having, as a cylindrical substrate, a metal cylinder produced by the method for producing a metal cylinder according to the exemplary embodiment, thereby suppressing the occurrence of dot defects in the toner image due to recessed portions present in the outer peripheral surface of the metal cylinder.

Examples of an image forming apparatus applied to the image forming apparatus according to the exemplary embodiment include known image forming apparatuses such as an apparatus provided with a fixing unit that fixes a toner image transferred to a surface of a recording medium; a direct-transfer type apparatus in which a toner image formed on the surface of an electrophotographic photoconductor is directly transferred to a recording medium; an intermediate transfer type apparatus in which a toner image formed on the surface of an electrophotographic photoconductor is first transferred to a surface of an intermediate transfer body and then the toner image transferred to the surface of the intermediate transfer body is second transferred to a surface of a recording medium; an apparatus provided with a cleaning unit that cleans the surface of an electrophotographic photoconductor before charging after transfer of a toner image; an apparatus provided with a static eliminating unit that eliminates electricity in the surface of an electrophotographic photoconductor by irradiation with static eliminating light before charging after transfer of a toner image; an apparatus provided with an electrophotographic photoconductor heating member that increases the temperature of the electrophotographic photoconductor to decrease the relative temperature; and the like.

In the case of the intermediate transfer-type apparatus, an example of a configuration applied to the transfer unit includes an intermediate transfer body in which a toner image is transferred to a surface, a first transfer unit in which the toner image formed on the surface of the electrophotographic photoconductor is first transferred to the surface of the intermediate transfer body, and a second transfer unit in which the toner image formed on the surface of the intermediate transfer body is second transferred to a surface of the recording medium.

The image forming apparatus according to the exemplary embodiment may be either a dry development-type image forming apparatus or a wet-development type (development type using a liquid developer) image forming apparatus.

In the image forming apparatus according to the exemplary embodiment, for example, a portion provided with the electrophotographic photoconductor may have a cartridge structure (process cartridge) detachable from the image forming apparatus. For example, a process cartridge used as the process cartridge is one provided with the electrophotographic photoconductor manufactured by the method for manufacturing an electrophotographic photoconductor according to the exemplary embodiment. Besides the electrophotographic photoconductor, the process cartridge may be provided with at least one selected from the group consisting of a charging unit, an electrostatic latent image forming unit, a development unit, and a transfer unit.

An example of the image forming apparatus according to the exemplary embodiment is described below, but the apparatus is not limited to this example. In addition, the portions shown in the drawings are described, and description of the other portions is omitted.

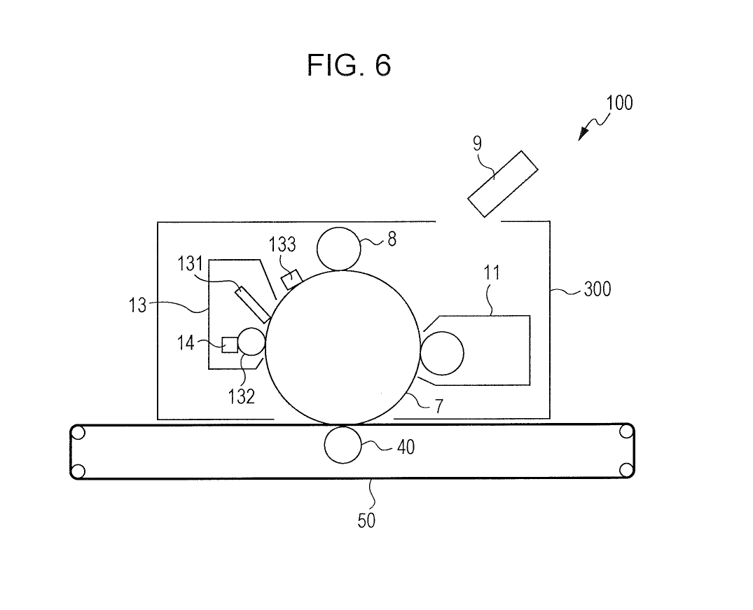

FIG. 6 is a schematic configuration diagram showing an example of the image forming apparatus according to the exemplary embodiment.

As shown in FIG. 6, an image forming apparatus 100 according to the exemplary embodiment includes a process cartridge 300 provided with an electrophotographic photoconductor 7, an exposure device 9 (an example of the electrostatic latent image forming unit), a transfer device 40 (first transfer device), and an intermediate transfer body 50. In the image forming apparatus 100, the exposure device 9 is disposed at a position where the electrophotographic photoconductor 7 may be exposed from an opening of the process cartridge 300. The transfer device 40 is disposed at a position facing the electrophotographic photoconductor 7 through the intermediate transfer body 50, and the intermediate transfer body 50 is disposed so as to be in partial contact with the electrophotographic photoconductor 7. Although not shown in the drawing, the image forming apparatus 100 also includes a second transfer device that transfers the toner image transferred to the intermediate transfer body 50 to the recording medium (for example, paper). The intermediate transfer body 50, the transfer device 40 (first transfer device), and the second transfer device (not shown) correspond to an example of the transfer unit.

The process cartridge 300 shown in FIG. 6 includes a housing in which the electrophotographic photoconductor 7, the charging device 8 (an example of the charging unit), the development device 11 (an example of the development unit), and a cleaning device 13 (an example of the cleaning unit) are integrally supported. The cleaning device 13 has a cleaning blade (an example of a cleaning member) 131 which is disposed in contact with the surface of the electrophotographic photoconductor 7. The cleaning member may be a conductive or insulating fibrous member, not the form of the cleaning blade 131, and the cleaning member may be used singly or used in combination with the cleaning blade 131.

FIG. 6 shows an example of the image forming apparatus in which a fibrous member 132 (roll-shaped) that supplies a lubricant 14 to the surface of the electrophotographic photoconductor 7, and a fibrous member 133 (plat-brush-shaped) that assists cleaning are provided. However, these members are disposed according to demand.

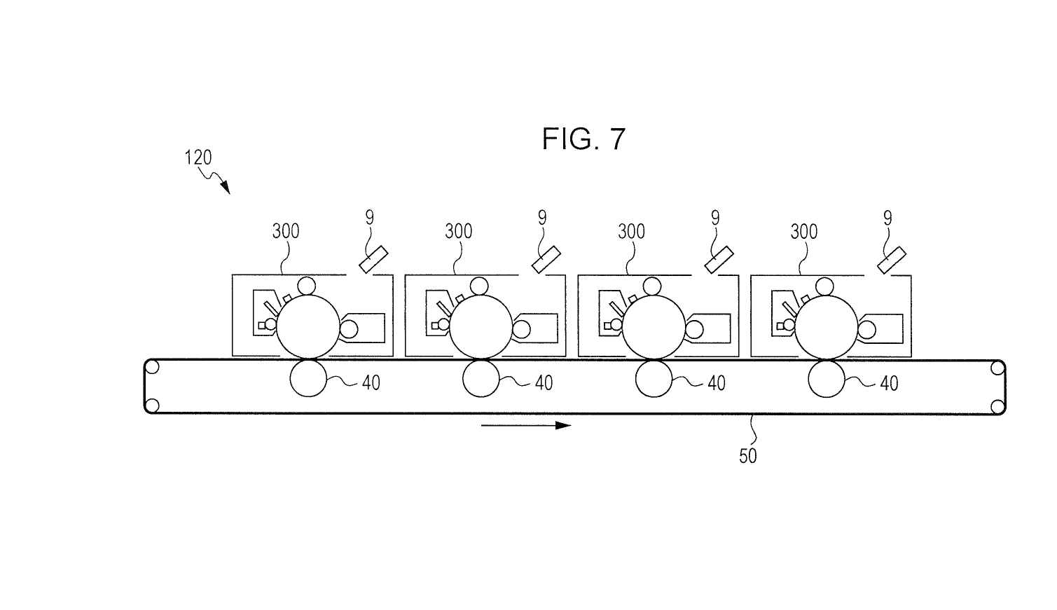

FIG. 7 is a schematic configuration diagram showing another example of the image forming apparatus according to the exemplary embodiment.

An image forming apparatus 120 shown in FIG. 7 is a tandem-system multicolor image forming apparatus provided with four process cartridges 300. The image forming apparatus 120 is configured so that the four process cartridges 300 are arranged in parallel on an intermediate transfer body 50, and an electrophotographic photoconductor is used for one color. The image forming apparatus 120 has the same configuration as the image forming apparatus 100 except being of a tandem system.

In the description of the embodiments, description is mainly made of a case in which the cylindrical substrate for an electrophotographic photoconductor is produced by the method for producing a metal cylinder according to the exemplary embodiment, but the method for producing a metal cylinder according to the exemplary embodiment is not limited to the method for producing a cylindrical substrate for an electrophotographic photoconductor. The method for producing a metal cylinder according to the exemplary embodiment may be applied to, for example, production of a cylindrical substrate such as a charging roll, a transfer roll, or the like in an image forming apparatus, and production of a cylinder of an apparatus other than an image forming apparatus, such as a capacitor case, a battery case, a marker pen, or the like.

### EXAMPLES

Examples of the present invention are described below, but the present invention is not limited to these examples below.

### Formation of Cylindrical Tube

### Comparative Example 1

An aluminum cylindrical slug having a diameter of 34 mm and a thickness of 15 mm is prepared by punching an aluminum plate having a thickness of 15 mm. As a result of measurement of the surface roughness Ra of an end surface of the slug by a surface roughness measuring instrument (Surfcom, manufactured by Tokyo Seimitsu Co., Ltd.), the surface roughness Ra is 1.0 μm.

Then, a lubricant is applied to the surface of the slug, and the slug is molded in a cylindrical shape having a diameter 34 mm by impact pressing.

Next, an aluminum cylindrical tube C1 having a diameter of 30 mm, a length of 251 mm, and a wall thickness of 0.5 mm is formed by two times of ironing.

Then, a recessed portion distribution on the outer peripheral surface of the resultant cylindrical tube is formed by using an automatic surface tester, and the number of recessed portions (a diameter of 30 μm or more) is measured.

Further, the positions of recessed portions in the outer peripheral surface of the cylindrical tube are specified based on the recessed portion distribution, and the sizes (diameter) of the recessed portions are measured by a laser microscope. As a result, the size of the maximum recessed portion is about 300 μm.

### Example 1

An aluminum cylindrical slug having a diameter of 34 mm and a thickness of 15 mm is prepared by punching an aluminum plate having a thickness of 15 mm. The slug is placed in a dry-type vibrating barrel polishing machine (manufactured by Tipton Corporation, abrasive: medium for a dry type) and polished for 60 minutes. The amount of polishing is 5 μm. As a result of measurement of the surface roughness Ra of an end surface of the polished slug by the same method as in Comparative Example 1, the surface roughness Ra is 1.8 μm.

Then, a lubricant is applied to the slug after polishing, and the slug is molded in a cylindrical shape having a diameter 34 mm by impact pressing.

Next, an aluminum cylindrical tube 1 having a diameter of 30 mm, a length of 251 mm, and a wall thickness of 0.5 mm is formed by two times of ironing.

Then, the number and sizes of recessed portions (a diameter of 30 μm or more) in the outer peripheral surface of the resultant cylindrical tube are measured by the same method as in Comparative Example 1. As a result, the number of recessed portions is decreased by about 30% as compared with the cylindrical tube produced in Comparative Example 1, and the size of the maximum recessed portion is about 200 μm.

### Example 2

An aluminum cylindrical slug having a diameter of 34 mm and a thickness of 15 mm is prepared by punching an aluminum plate having a thickness of 15 mm. The slug is placed in a wet-type centrifugal barrel polishing machine (manufactured by Tipton Corporation, abrasive: medium for a wet type) and polished for 15 minutes to form a slug sample. The amount of polishing is 15 μm. As a result of measurement of the surface roughness Ra of an end surface of the polished slug by the same method as in Comparative Example 1, the surface roughness Ra is 1.6 μm.

Then, a lubricant is applied to the slug after polishing, and the slug is molded in a cylindrical shape having a diameter 34 mm by impact pressing.

Next, an aluminum cylindrical tube 2 having a diameter of 30 mm, a length of 251 mm, and a wall thickness of 0.5 mm is formed by two times of ironing.

Then, the number and sizes of recessed portions (a diameter of 30 μm or more) in the outer peripheral surface of the resultant cylindrical tube are measured by the same method as in Comparative Example 1. As a result, the number of recessed portions is decreased by about 50% as compared with the cylindrical tube produced in Comparative Example 1, and the size of the maximum recessed portion is about 150 μm.

### Example 3

An aluminum cylindrical slug having a diameter of 34 mm and a thickness of 15 mm is prepared by punching an aluminum plate having a thickness of 15 mm. The slug is placed in a wet-type centrifugal barrel polishing machine (manufactured by Tipton Corporation, abrasive: medium for a wet type) and polished for 30 minutes to form a slug sample. The amount of polishing is 30 μm. As a result of measurement of the surface roughness Ra of an end surface of the polished slug by the same method as in Comparative Example 1, the surface roughness Ra is 1.1 μm.

Then, a lubricant is applied to the slug after polishing, and the slug is molded in a cylindrical shape having a diameter 34 mm by impact pressing.

Next, an aluminum cylindrical tube 3 having a diameter of 30 mm, a length of 251 mm, and a wall thickness of 0.5 mm is formed by two times of ironing.

Then, the number and sizes of recessed portions (a diameter of 30 μm or more) in the outer peripheral surface of the resultant cylindrical tube are measured by the same method as inn Comparative Example 1. As a result, the number of recessed portions is decreased by about 70% as compared with the cylindrical tube produced in Comparative Example 1, and the size of the maximum recessed portion is about 120 μm.

### [Production of Electrophotographic Photoconductor]

### (Formation of Undercoat Layer)

First, 100 parts by weight of zinc oxide (average particle diameter: 70 nm, manufactured by Tayca Corporation, specific surface area value 15 m²/g) is mixed with 500 parts by weight of tetrahydrofuran by stirring, and 1.3 parts by weight of a silane coupling agent (KBM503, manufactured by Shim-Etsu Chemical Co., Ltd.) is added to the resultant mixture and stirred for 2 hours. Then, tetrahydrofuran is distilled off by distillation under reduced pressure, and the residue is baked at 120° C. for 3 hours to produce zinc oxide surface-treated with the silane coupling agent.

Then, 110 parts by weight of the surface-treated zinc oxide and 500 parts by weight of tetrahydrofuran are mixed by stirring, and a solution prepared by dissolving 0.6 parts by weight of alizarin in 50 parts by weight of tetrahydrofuran is added to the resultant mixture and stirred at 50° C. for 5 hours. Then, alizarin-added zinc oxide is filtered off by reduced-pressure filtration and then dried at 60° C. under reduced pressure to produce alizarin-added zinc oxide.

Then, 60 parts by weight of the alizarin-added zinc oxide, 13.5 parts by weight of a curing agent (blocked isocyanate Sumidur 3175, manufactured by Sumitomo Bayer Urethane Co., Ltd.), 38 parts by weight of a solution prepared by dissolving 15 parts by weight of butyral resin (S-LEC BM-1, manufactured by Sekisui Chemical Co., Ltd.) in 85 parts by weight of methyl ethyl ketone, and 25 parts by weight of methyl ethyl ketone are mixed and dispersed for 2 hours with a sand mill using glass beads of 1 mmφ to produce a dispersion.

To the resultant dispersion, 0.005 parts by weight of dioctyltin dilaurate and 45 parts by weight of silicone resin particles (Tospearl 145, manufactured by Momentive Performance Materials Inc.) are added, thereby producing a coating solution for forming an undercoat layer. The resultant coating solution is applied, by a dip coating method, to the outer peripheral surface of each of the cylindrical tubes 1 to 3 and C1 produced in Examples 1 to 3 and Comparative Example 1 as a conductive support and dried and cured at 170° C. for 30 minutes to form an undercoat layer having a thickness of about 23 μm.

### (Formation of Charge Generation Layer)

Next, 1 part by weight of hydroxygallium phthalocyanine having diffraction peaks at Bragg angles (20)±0.2° of 7.5°, 9.9°, 12.5°, 16.3°, 18.6°, 25.1°, and 28.3° in an X-ray diffraction spectrum is mixed with 1 part by weight of polyvinyl butyral (S-LEC BM-S, manufactured by Sekisui Chemical Co., Ltd.) and 80 parts by weight of n-butyl acetate, and the resultant mixture is dispersed together with glass beads with a paint shaker for 1 hour to prepare a coating solution for forming a charge generation layer. The resultant coating solution is applied, by a dip coating method, to the conductive support on which the undercoat layer has been formed, and dried by heating at 100° C. for 10 minutes to form a charge generation layer having a thickness of about 0.15 μm.

### (Formation of Charge Transport Layer)

Next, 2.6 parts by weight of benzidine represented by formula (CT-1) below and 3 parts by weight of a polymer compound having a repeat unit represented by formula (B-1) below (viscosity-average molecular weight: 40,000) are dissolved in 25 parts by weight of tetrahydrofuran to prepare a coating solution for forming a charge transport layer. The resultant coating solution is applied, by a dip coating method, to the charge generation layer and heated at 130° C. for 45 minutes to form a charge transport layer having a thickness of 20 μm. Consequently, electrophotographic photoconductors 1 to 3 and C1 are produced.

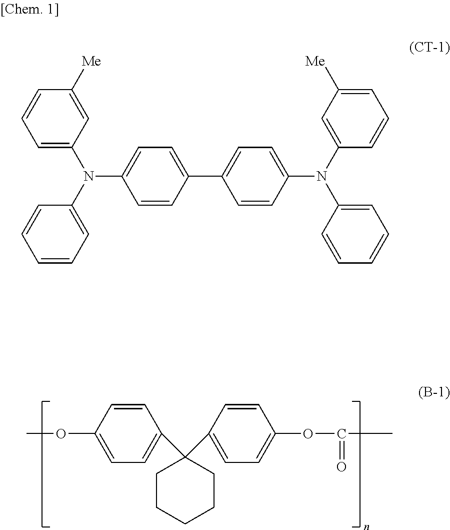

### [Evaluation and Results]

Each of the produced electrophotographic photoconductors 1 to 3 and C1 is loaded on a process cartridge of DocuPrint P450 manufactured by Fuji Xerox Co., Ltd., and a halftone image with a 50% density is output on A4 paper (manufactured by Fuji Xerox Co., Ltd., C2 paper) in an environment at 25° C. and 60% RH. The occurrence of white dots having a diameter of 0.5 mm or more is evaluated in an image on the 20th paper.

As a result, when the electrophotographic photoconductors 1 to 3 of Example 1 to 3 are used, no white dots occurred. However, when the electrophotographic photoconductor C1 of Comparative Example 1 is used, white dots with a diameter of 0.5 mm or more occurred at five positions.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A method for producing a metal cylinder, the method comprising:
preparing a metal slug having a polished surface; and
molding the metal slug into a cylinder by impact pressing with the polished surface as a bottom.

2. The method for producing a metal cylinder according to claim 1, wherein the metal slug contains aluminum.

3. The method for producing a metal cylinder according to claim 1, wherein the preparation includes forming the metal slug having the polished surface by polishing an unpolished metal slug in an amount of polishing of 30 μm or less.

4. The method for producing a metal cylinder according to claim 1, wherein the preparation includes forming the metal slug having the polished surface by a wet centrifugal barrel polishing method for polishing an unpolished metal slug.

5. The method for producing a metal cylinder according to claim 1, wherein the preparation includes preparing a metal slug having the polished surface with a surface roughness Ra of less than 5 μm as the metal slug having the polished surface.

6. The method for producing a metal cylinder according to claim 1, wherein the preparation includes preparing a metal slug having the polished surface with a surface roughness Ra of 3 μm or less as the metal slug having the polished surface.

7. The method for producing a metal cylinder according to claim 1, wherein the preparation includes preparing a metal slug having the polished surface with a surface roughness Ra of 1 μm or less as the metal slug having the polished surface.

8. The method for producing a metal cylinder according to claim 5, wherein the preparation includes preparing a metal slug having the polished surface with a surface roughness Ra of 0.5 μm or more as the metal slug having the polished surface.

9. The method for producing a metal cylinder according to claim 1, further comprising ironing the cylinder after the impact pressing.

10. A metal slug for impact pressing, having a polished surface with a surface roughness Ra of less than 5 μm.

11. The metal slug for impact pressing according to claim 10, having a polished surface with a surface roughness Ra of 3 μm or less.

12. The metal slug for impact pressing according to claim 10, having a polished surface with a surface roughness Ra of 1 μm or less.

13. The metal slug for impact pressing according to claim 10, having a polished surface with a surface roughness Ra of 0.5 μm or more.

14. A method for producing a substrate for an electrophotographic photoconductor by the method for producing a metal cylinder according to claim 9.

15. A method for manufacturing an electrophotographic photoconductor, the method comprising:
preparing, as a substrate for an electrophotographic photoconductor, a metal cylinder produced by the method for producing a metal cylinder according to claim 9; and
forming a photosensitive layer on the outer peripheral surface of the substrate for an electrophotographic photoconductor.
